(19) United States
(12) Patent Application Publication
(10) Pub. No.: US 2011/0293349 A1
(43) Pub. Date: Dec. 1, 2011

(54) PRINTER WITH VARIABLE LENGTH RECEIVER SUPPLY

(76) Inventors: Thomas N. Tombs, Rochester, NY (US); James D. Shifley, Spencerport, NY (US); Walter B. Sherwood, Rochester, NY (US); Gary P. Lawniczak, Rochester, NY (US); David E. Bettiol, Rush, NY (US)

(21) Appl. No.: 12/789,934

(22) Filed: May 28, 2010

(51) Int. Cl. B41J 11/42

(52) U.S. Cl. 400/583

(57) ABSTRACT

Printers with variable receiver supply are provided. In one aspect a printer is provided having a source of image data and production data for use in printing a set of images, with each image having a defined size and shape and a receiver supply having a web of receiver and a cutter adapted to cut the web of receiver to a determined length. The printer also has print engine to print the images on the receiver and a finishing system that is configurable between at least two configurations. A user input system receives user input from which a priority setting can be determined between an output rate priority and an efficiency priority; and a controller determines the configuration of the finishing system, receives the image data and production data and determines a priority setting. The controller determines an organization of the images for printing the images on the receiver in the defined sizes and shapes based upon the determined priority setting and the determined configuration of the finishing system and the controller determines a length of the receiver based on the organization of the images and causes the cutter to cut the web of receiver to supply the determined length of the receiver.

### CROSS REFERENCE TO RELATED APPLICATIONS

This application relates to commonly assigned, copending U.S. application Ser. No. ______ (Docket No. 96225RRS), filed ______, entitled: “METHOD FOR PRINTING A SET OF IMAGES” hereby incorporated by reference.

### FIELD OF THE INVENTION

This invention pertains to the field of printing.

### BACKGROUND OF THE INVENTION

Printers generally form images by delivering patternwise applications of a donor material to a receiver or by altering the receiver so that visible contrast patterns appear thereon. Receiver that used in printing is generally supplied either in cut sheet form or in continuous web form such as a fan folded or roll form. As is well known in the art, the web form has the advantage of being able to be cut to a desired length to allow greater flexibility in the printing and/or finishing processes.

Typically in the prior art, the cut length of a web for of receiver is either set to one of a predetermined conventional cut length sizes such as the A0, A1, A2, A3 or A4 size or 8.5″×11″, 11″×14″ or other well known sizes. A wide variety of cutters are known that can cut roll of receiver to such sizes including, but not limited to those that are described in U.S. Pat. Nos. 5,216,471 and 5,375,494, both entitled “Image forming Apparatus and Roll Paper Cutting Machine” and issued on Jun. 1, 1993 and Dec. 27, 1994 respectively and in U.S. Pat. No. 5,751,298, entitled “System and Method for Directly Feeding Paper to Printing Devices” issued on May 12, 1998.

Alternatively it has been known in the copying arts to attempt to size a receiver on which a copy will be printed to a size of an original as is described generally in U.S. Pat. No. 4,265,153 entitled “Copy Machine with Automatic Roll Supplied Copy Paper Feeding and Cutting Apparatus and Control Circuitry”, U.S. Pat. No. 5,708,345 entitled “Compact Sheet Cutter for A Document Reproduction Machine” issued on Jan. 13, 1998.

In digital printing, it is of course possible to adjust the orientation of or other characteristics images to be printed so as to provide prints that can be printed more quickly and with less use of receiver. For example, U.S. Pat. No. 5,151,717, entitled “Imaging Method and Apparatus Using Discrete Receiving Sheets” describes the use an electrophotographic imaging system that can render images on a receiving sheet that is large enough to receive one image of a largest size or an array of smaller sized images. The receiving sheet with smaller images is cut to size after transfer. Similarly, U.S. Pat. No. 4,706,099 describes a laser printer that determines when the size of an image to be printed is no greater than one half of the width of the maximum print size a plurality of images are printed within the maximum print size. Such prints are then separated in a finishing operation that is performed subsequent to printing. However, it will be appreciated that the decision to print in such a manner impacts not only the printing process, but also the finishing processes and can also impact post finishing operations by increasing post printing labor required to sort or organize images. The decision to print in such a manner can also directly impact the size of a receiver to be used in printing.

For these reasons an operator of a printer must consider many factors in determining how to execute the printing of a set of digital images. It can be burdensome for an operator to make this number of decisions for each print job.

Accordingly what is needed in the art is a new approach to operating a printer to allow the printer to make automatic decisions that allow the flexibility of digital printing and configurable finishing systems to be used and to inform the operation of a receiver supply that supplies a variable length of receiver for printing.

### SUMMARY OF THE INVENTION

Printers with variable receiver supply are provided. In one aspect a printer is provided having a source of image data and production data for use in printing a set of images, with each image having a defined size and shape and a receiver supply having a web of receiver and a cutter adapted to cut the web of receiver to a determined length. The printer also has print engine to print the images on the receiver and a finishing system that is configurable between at least two configurations. A user input system receives user input from which a priority setting can be determined between an output rate priority and an efficiency priority; and a controller determines the configuration of the finishing system, receives the image data and production data and determines a priority setting. The controller determines an organization of the images for printing the images on the receiver in the defined sizes and shapes based upon the determined priority setting and the determined configuration of the finishing system and the controller determines a length of the receiver based on the organization of the images and causes the cutter to cut the web of receiver to supply the determined length of the receiver.

### BRIEF DESCRIPTION OF THE DRAWINGS

FIG. 1 is a system level illustration of one embodiment of an electrophotographic printer.

FIG. 2 shows one embodiment of receiver supply that is usable with the printer of FIG. 1.

FIG. 3 shows a first embodiment of a method for operating a printer.

FIG. 4 shows one possible organization for the printing of a set of images.

FIG. 5 shows one possible organization for the printing of a set of images.

FIG. 6 shows one possible organization for the printing of a set of images.

FIG. 7 shows a second embodiment of a method for operating a printer.

FIG. 8 shows an example of an organization a set of images for printing on a plurality of receiver sheets.

FIG. 9 shows another example of an organization of a set of images for printing on a plurality of receiver sheets.

FIG. 10 shows yet another example of an organization a set of images for printing on a plurality of receiver sheets.

FIG. 11 shows a further example of an organization a set of images for printing on a plurality of receiver sheets.

### DETAILED DESCRIPTION OF THE INVENTION

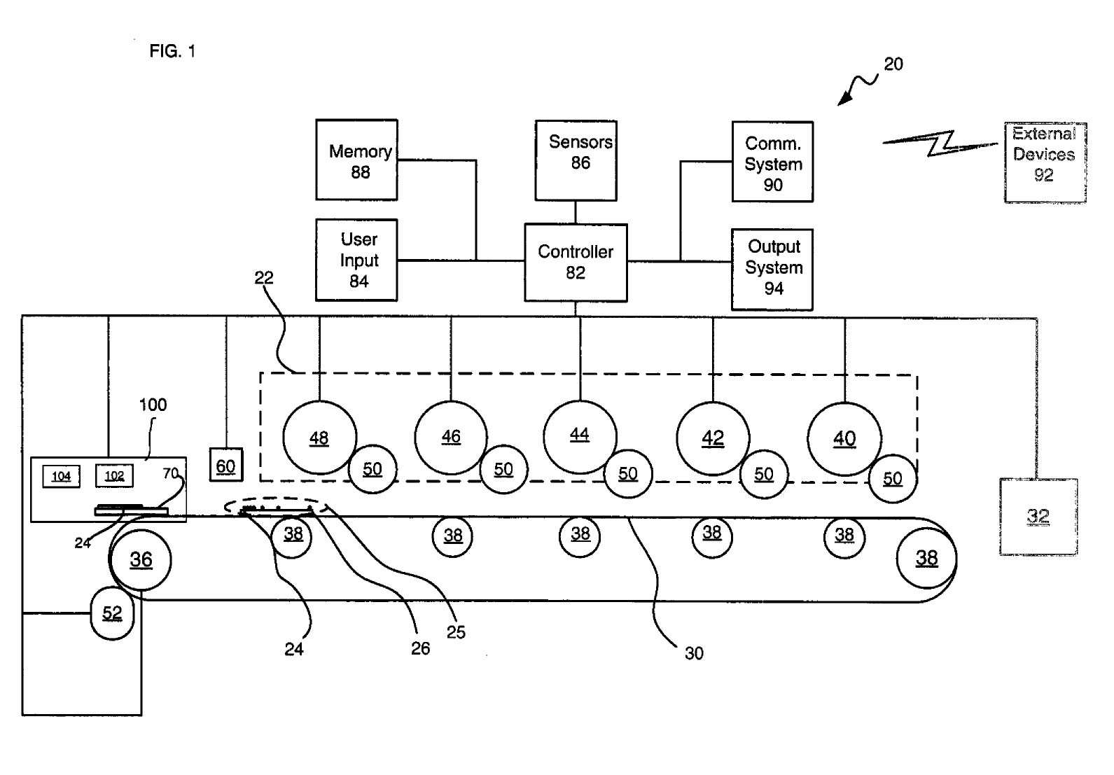

FIG. 1 is a system level illustration of an electrophotographic printer 20. In the embodiment of FIG. 1, electrophotographic printer 20 has an electrophotographic print engine 22 that deposits toner 24 to form a toner image 25 in the form of a patterned arrangement of toner stacks. Toner image 25 can include any patternwise application of toner 24 and can be mapped according data representing text, graphics, photo, and other types of visual content, as well as patterns that are determined based upon desirable structural or functional arrangements of the applied toner 24.

Toner 24 is a material or mixture that contains toner particles, and that can form an image, pattern, or coating when electrostatically deposited on an imaging member including a photoreceptor, photoconductor, electrostatically-charged, or magnetic surface. As used herein, “toner particles” are the marking particles used in an electrophotographic print engine 22 to convert an electrostatic latent image into a visible image. Toner particles can also include clear particles that can provide for example a protective layer on an image or that impart a tactile feel to the printed image.

Toner particles can have a range of diameters, e.g. less than 8 μm, on the order of 10-15 μm, up to approximately 30 μm, or larger. When referring to particles of toner 24, the toner size or diameter is defined in terms of the median volume weighted diameter as measured by conventional diameter measuring devices such as a Coulter Multisizer, sold by Coulter, Inc. The volume weighted diameter is the sum of the mass of each toner particle multiplied by the diameter of a spherical particle of equal mass and density, divided by the total particle mass. Toner 24 is also referred to in the art as marking particles or dry ink.

Typically, receiver 26 takes the form of paper, film, fabric, metallicized or metallic sheets or webs. However, receiver 26 can take any number of forms and can comprise, in general, any article or structure that can be moved relative to print engine 22 and processed as described herein.

Returning again to FIG. 1, print engine 22 can be used to deposit one or more applications of toner 24 to form toner image 25 on receiver 26. A toner image 25 formed from a single application of toner 24 can, for example, provide a monochrome image.

A toner image 25 formed from more than one application of toner 24, (also known as a multi-part image) can be used for a variety of purposes, the most common of which is to provide toner images 25 with more than one color. For example, in a four toner image, four toners having subtractive primary colors, cyan, magenta, yellow, and black, can be combined to form a representative spectrum of colors. Similarly, in a five toner image various combinations of any of five differently colored toners can be combined to form other colors on receiver 26 at various locations on receiver 26. That is, any of the five colors of toner 24 can be combined with toner 24 of one or more of the other colors at a particular location on receiver 26 to form a color different than the colors of the toners 24 applied at that location.

In the embodiment that is illustrated, a primary imaging member (not shown) such as a photoreceptor is initially charged. An electrostatic latent image is formed by image-wise exposing the primary imaging member using known methods such as optical exposure, an LED array, or a laser scanner. The electrostatic latent image is developed into a visible image by bringing the primary imaging member into close proximity to a development station that contains toner 24. The toner image 25 on the primary imaging member is then transferred to receiver 26, generally by pressing receiver 26 against the primary imaging member while subjecting the toner to an electrostatic field that urges the toner to receiver 26. The toner image 25 is then fixed to receiver 26 by fusing to become a print 70.

In FIG. 1 print engine 22 is illustrated as having an optional arrangement of five printing modules 40, 42, 44, 46, and 48, also known as electrophotographic imaging subsystems arranged along a length of receiver transport system 28. Each printing module delivers a single application of toner 24 to a respective transfer subsystem 50 in accordance with a desired pattern as receiver 26 is moved by receiver transport system 28. Receiver transport system 28 comprises a movable surface 30, positions that moves receiver 26 relative to printing modules 40, 42, 44, 46, and 48. Surface 30 comprises an endless belt that is moved by motor 36, that is supported by rollers 38, and that is cleaned by a cleaning mechanism 52.

Electrophotographic printer 20 is operated by a controller 82 that controls the operation of print engine 22 including but not limited to each of the respective printing modules 40, 42, 44, 46, and 48, receiver transport system 28, receiver supply 32, transfer subsystem 50, to form a toner image 25 on receiver 26 and to cause fuser 60 to fuse toner images 25 on receiver 26 to form prints 70 as described herein.

Controller 82 operates electrophotographic printer 20 based upon input signals from a user input system 84, sensors 86, a memory 88 and a communication system 90. User input system 84 can comprise any form of transducer or other device capable of receiving an input from a user and converting this input into a form that can be used by controller 82. For example, user input system 84 can comprise a touch screen input, a touch pad input, a 4-way switch, a 6-way switch, an 8-way switch, a stylus system, a trackball system, a joystick system, a voice recognition system, a gesture recognition system or other such systems. Sensors 86 can include contact, proximity, magnetic, or optical sensors and other sensors known in the art that can be used to detect conditions in electrophotographic printer 20 or in the environment-surrounding electrophotographic printer 20 and to convert this information into a form that can be used by controller 82 in governing printing and fusing. Memory 88 can comprise any form of conventionally known memory devices including but not limited to optical, magnetic or other movable media as well as semiconductor or other forms of electronic memory. Memory 88 can be fixed within electrophotographic printer 20 or removable from electrophotographic printer 20 at a port, memory card slot or other known means for temporarily connecting a memory 88 to an electronic device. Memory 88 can also be connected to electrophotographic printer 20 by way of a fixed data path or by way of communication system 90.

Communication system 90 can comprise any form of circuit, system or transducer that can be used to send or receive signals to memory 88 or external devices 92 that are separate from or separable from direct connection with controller 82. Communication system 90 can connect to external devices 92 by way of a wired or wireless connection. In certain embodiments, communication system 90 can comprise a circuitry that can communicate with such separate or separable device using a wired local area network or point to point connection such as an Ethernet connection. In certain embodiments, communication system 90 can alternatively or in combination provide wireless communication circuits for communication with separate or separable devices using a Wi-Fi or any other known wireless communication systems. Such systems can be networked or point to point communication.

External devices 92 can comprise any type of electronic system that can generate signals bearing data that may be useful to controller 82 in operating electrophotographic printer 20. For example and without limitation, an external device 92 can comprise what is known in the art as a digital front end (DFE), which is a computing device that can be used to provide a source of image data and, optionally, production data including printing information from which the manner in which the images are to be printed can be determined. Optionally the production data can include finishing information that defines how the images that are provided are to be processed after printing. Similarly, image and production data can be obtained from any other source that can provide such data to printer 20 by any other manner, including but not limited to memory 88. Further, in certain embodiments image data and/or production data or certain aspects thereof can be generated from a source at printer 20 such as by use of user input system 84 and an output system 94, such as a display, audio signal source or tactile signal generator or any other device that can be used by controller 82 to provide human perceptible signals for feedback, informational or other purposes.

As is shown in FIG. 1, electrophotographic printer 20 further comprises a finishing system 100. Finishing system 100 can be integral to printer 20 or it can be separate or separable from printer 20. In the embodiment that is illustrated, finishing system 100 has a cutting system 102 and an optional folding system 104. Cutting system 102 can comprise any form of automatic cutting system that can be adjusted to cut a print 70 in at least two parts. Similarly, folding system 104 can comprise any form of automatic folding system that can be used to fold a print 70 in at least two parts.

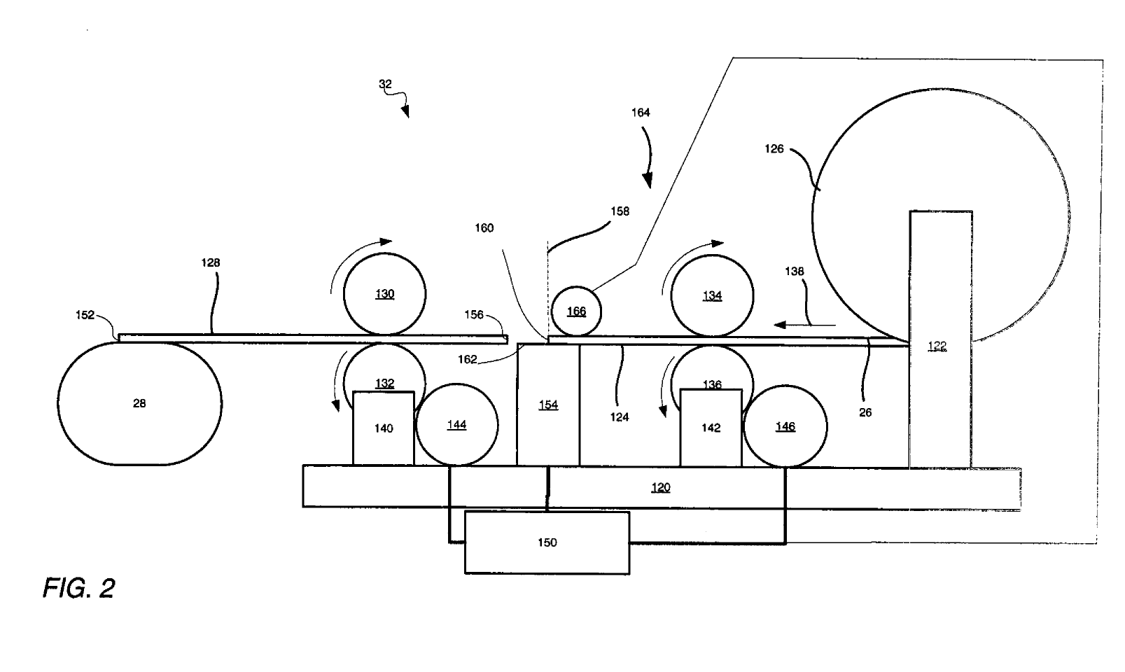

FIG. 2 shows one embodiment of receiver supply 32 in greater detail. Receiver supply 32 can be integral to printer 20 or it can be separate or separable from printer 20.

As is shown in this embodiment, receiver supply 32 comprises a frame 120 having a support structure 122 on which a web 124 of receiver 26 is positioned for supply to printer 20. In this embodiment, web 124 is supplied from a roll 126 of receiver 26 that is supported by support structure 122. In other embodiments web 124 is provided in fan fold format and is drawn as needed from as stack (not shown) that is supported by support structure 122.

Web 124 of receiver 26 is drawn through a pair of lead pinch rollers 130 and 132 and trailing pinch rollers 134 and 136. Pinch rollers 130 and 134 are positioned in opposition to pinch rollers 132 and 136 across a receiver supply transport path 138 and biased against each other by biasing members 140 and 142. A first pinch roller motor 144 drives one of lead pinch rollers 130 and 132, here shown as pinch roller 132, to cause lead pinch rollers 130 and 132 to rotate in the directions as shown, and a second pinch roller motor 146 drives one of trailing pinch roller 134 or trailing pinch roller 136, shown here as pinch roller 136, to cause trailing pinch rollers 134 and 136 to rotate in the directions shown to provide receiver 26 to receiver transport system 28.

A supply controller 150 is connected to first pinch roller motor 144 and to second pinch roller motor 146 to drive web 124, receiver 26 from roll 126 past a cutter 154 that is also controlled by supply controller 150. Cutter 154 is adapted to cut web 124 of receiver 26 at cut line 158 to separate web 124 to form a cut sheet 128 of receiver 26. Cutter 154 can comprise any known cutting or slitting technology that can cut web 124 of receiver 26 in response to electronic or other control signals. Similarly, supply controller 150 can take the form of any electronic system that can receive signals from controller 82 and that can use pinch roller motors 144 and 146 and cutter 154 and a sensor system 164 to act to cut web 124 as described herein.

In embodiments where receiver supply 32 is separate from or separable from printer 20, supply controller 150 can include any known communication circuit (not shown) that is adapted to communicate with controller 82 by way of communication system 90. In embodiments where receiver supply 32 is integral to printer 20, the functions described herein as being performed by supply controller 150 are optionally performed by controller 82.

When controller 82 sends an appropriate signal, supply controller 150 sends appropriate signals to cause receiver 26 to be advanced so that a leading edge 152 of receiver 26 is moved from lead pinch rollers 130 and 132 to receiver transport system 28. After cutting, a trailing edge 156 continues to be moved by lead pinch rollers 130 and 132 to receiver transport system 28. As shown a leading edge 160 of the remaining web 124 is supported on a surface 162 of cutter 154 and is advanced by trailing pinch rollers 134 and 136 until gripped by lead pinch rollers 130 and 132 in advance making the next sheet 128 receiver 26. The cutting of sheet 128 of receiver 26 from web 124 of receiver 26 is preferably done before or after printing is complete so that the cutting does not interrupt the printing process. However, in certain embodiments the cutting of sheet 128 can occur during printing as well.

Sensor system 164 has at least one supply sensor 166 arranged to provide signals from which supply controller 150 can determine a extent of receiver 26 supplied past cutter 154. In the embodiment that is illustrated supply sensor 166 comprises a follower wheel that rests on receiver 26 that rotates as web 124 of receiver 26 is moved past a point that is proximate to cut line 158 and that generates a signal that supply controller 150 can use to determine a length of receiver web 124 that has moved past cut line 158. This embodiment of supply sensor 166 and sensor system 164 is not limiting and there are a wide variety of other types and arrangements of sensors known to those of skill in the art that can be used for the purpose of sensing a condition from which supply controller 150 can determine an amount of receiver 26 from a web 124 that has moved past cut line 158.

In operation, supply controller 150 receives instructions from controller 82 indicating a length of receiver 26 that is to be supplied to receiver transport system 28. Alternatively, supply controller 150 cuts web 124 to form a sheet 128 having when instructed to do so by controller 82. Other variations known to those of skill in the art can be used to determine the exact information or control signals that controller 82 proves to supply controller 150 and the exact information or control signals, if any, returned by supply controller 150 to controller 82 in the process of causing a sheet 128 of receiver 26 to be supplied to receiver transport system 28.

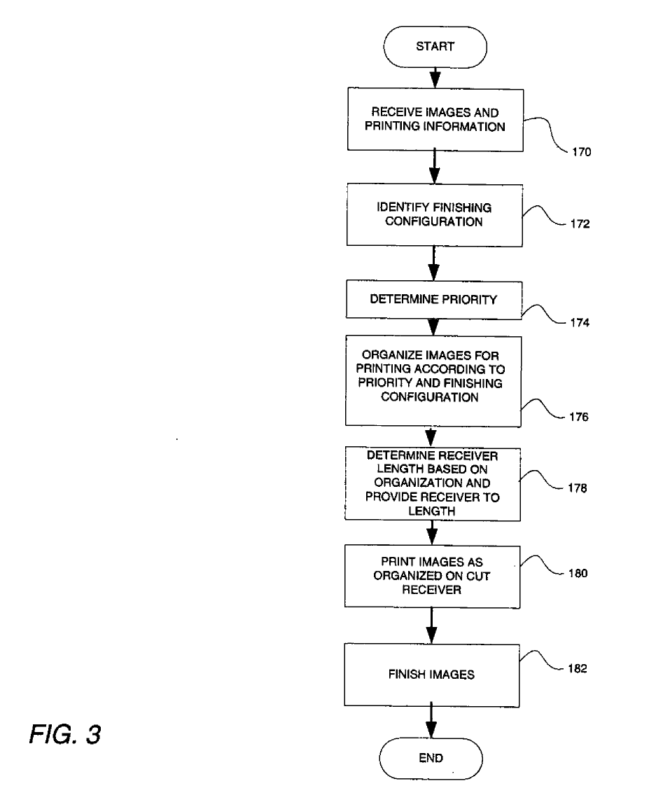

FIG. 3 shows a first embodiment of a method for operating a printer such as printer 20 as shown in FIGS. 1 and 2. In a first step of this method, controller 82 receives image data and production data for use in printing a set of images including data that controller 82 can use to define at least a size and shape for each image (step 170). The image and production data can be received as generally described above or in any other manner known to those of skill in the art.

Controller 82 then identifies a finishing configuration of finishing system 100 (step 172). In this embodiment, finishing system 100 comprises cutting system 102 and an optional automatic folding system 104. Each of these systems will have an initial finishing configuration for processing a print 70 that is made having the set of images printed on it. For example, a cutting system 102 will be configured to apply a one of a plurality of different cutting patterns to a print 70 as the print 70 is moved to finishing system 100. Often, cutting system 102 will have the configuration used for processing the last print (not shown).

Similarly, an optional automatic folding system 104 can be configured at any of a plurality of different settings when a print 70 will be provided to folding system 104 for folding. For example, folding system 104 might be configured to fold parallel to a path of travel of a print 70 past folding system 104 or folding system 104 might be configured to fold across a path of travel of a print 70 past folding system 104. It will be appreciated that there are a variety of other configurations for both cutting system 102 and folding system 104 and for any other known finishing devices that may be incorporated in finishing system 100.

Controller 82 identifies the finishing configuration of the components in finishing system 100 such as cutting system 102 and folding system 104. This can be done based on stored information regarding the configuration, based on sensor sensors (not shown) in finishing system 100 that can be used to determine the configuration of finishing system or by exchanging data with a controller (not shown) in finishing system 100.

Controller 82 then determines a priority setting for printer 20 (step 174). In this embodiment, the priority setting includes an output rate priority setting and an efficiency priority setting. Typically, the priority setting will be entered at printer 20 using user input system 84 and output system 94. However the priority setting can be generated remotely and sent to printer 20 by way of communication system 90.

In general, it will be appreciated that because printer 20 is capable of rendering images on receiver 26 that have a variety of different orientations and because finishing system 100 is capable of finishing a print 70 generated using receiver 26 in a variety of different ways there is more than one way in which a set of images can be printed and finished in accordance with the production data.

Accordingly, there are many ways in which an operator of printer 20 can organize images and finishing operations to execute the printing of a set of images. Typically, it has been left to the operator of printer 20 to determine which of way to operate printer 20. As noted above, this involves making many decisions regarding the printing which may or may not result in the most effective use of printer 20 at any given time.

The use of the priority setting simplifies this problem by reducing the decision making required of an operator of printer 20 to a single decision that can be used to guide controller 82 such that controller 82 makes automatic selections from among a combination of available possible options that can result in the printing of a set of images.

Accordingly, here an operator of printer 20 is asked to make a priority setting that is here characterized as being either one of an output rate priority setting or an efficiency priority setting. The priority setting can be made by an operation of printer 20 for example, by way of user input system 84 and output system 94 or by using a separate device that is in communication with communication system 90. Once that controller 82 determines that a priority setting is made, controller 82 can take appropriate steps to optimize or otherwise adjust the printing process accordingly. These optimizations or adjustments can be implemented without further decision making on the part of the operator of printer 20. As will be described in greater detail below, these optimizations or adjustments can impact image organization and receiver length determinations.

Specifically, in this embodiment the priority setting is used to organize the set of images for printing on receiver 26 in the defined sizes and shapes. For example, where a production rate priority setting is determined, controller 82 will organize the set of images for printing so that they will be printed in a manner that can be most quickly printed and finished for delivery.

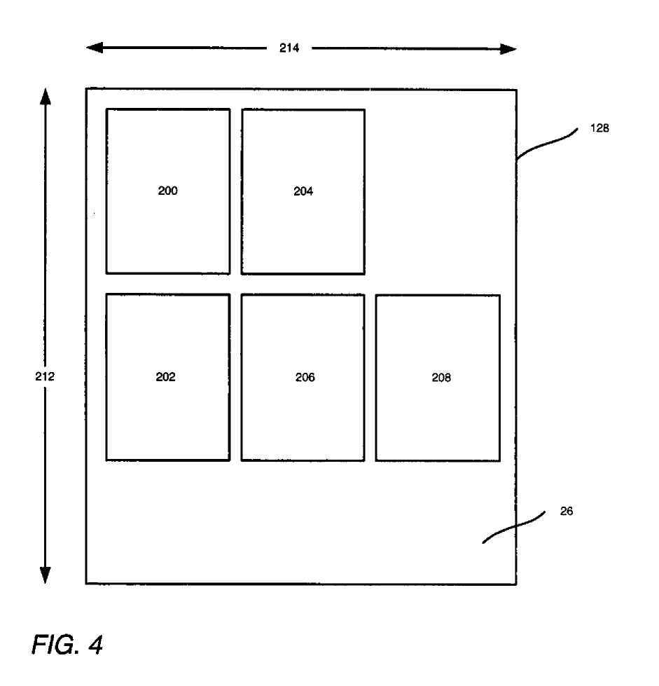

FIG. 4 shows one possible organization for the printing of a set of images 200, 202, 204, 206 and 208 that are of the same size and shape on receiver 26 in accordance that can be used when an output rate priority setting is determined. It will be appreciated that this is done for convenience and that in practice the sizes and shapes of the images in a set of images can vary. As is shown in the example of FIG. 4, in this situation, the set of images 200, 202, 204, 206 and 208 are organized with a long sides arranged across a width 212 of receiver 26 with images 200 and 202 in a first row along a first length 214 of receiver 26, with images 204 and 206 in a second row along first length 214 of receiver 26 and with image 208 in a third row along first length 214 of receiver 26.

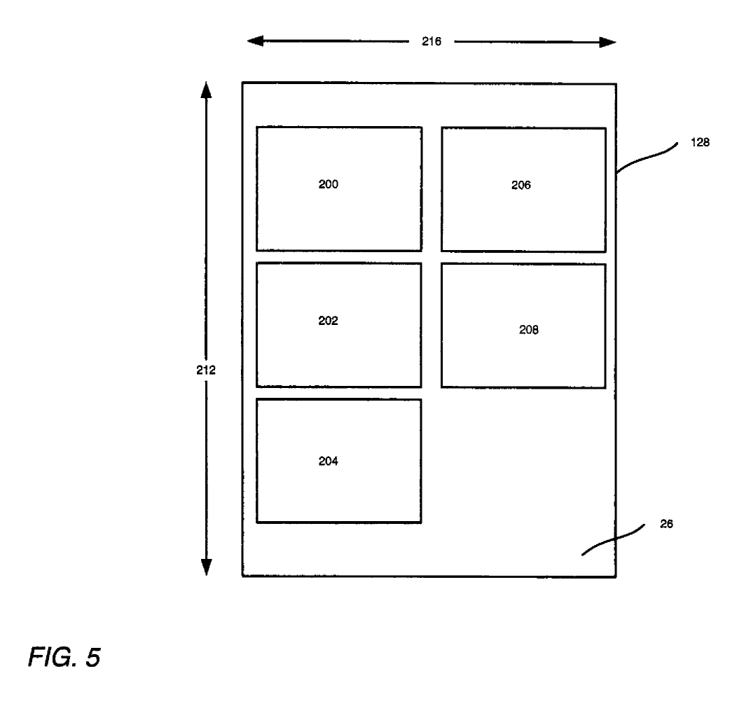

FIG. 5 shows another possible organization for the same set of images 200, 202, 204, 206, and 208 on a receiver 26 that can also be made when a production rate priority setting is determined. Here the set of images 200, 202, 204, 206 and 208 are organized for printing on receiver 26 with a short side of images 200, 202, 204, 206 and 208 arranged parallel to width 212 of receiver 26 such that images 200, 202 and 206 are arranged in a first row along a second length 216 of receiver 26 and so that images 206 and 208 are arranged for printing in a second row along second length 216 of receiver 26.

It will be appreciated that both the organization of the set of images shown in FIG. 4 and the organization shown in FIG. 5 provide options that will result in the printing of the set of images 200, 202, 204, 206 and 208. The embodiment of FIG. 5 will generally result in a faster printing of the set of images 202, 204, 206 and 208 as the second length 216 of receiver 26 that must be printed is less than the first length 214 of receiver 26 according to the arrangement of FIG. 4.

While this may indicate that a production rate priority setting would dictate the use of the print organization shown in FIG. 5, it will be appreciated that the production of the prints based on images 200, 202, 204, 206 and 208 also requires the use of a finishing operation by cutting system 102 to produce separate prints based on images 200, 202, 204, 206 and 208. Where, as here, cutting system 102 can be set to multiple different configurations either organization of the set of images 200, 202, 204, 206 and 208 can be cut by cutting system 102. However, depending on the configuration of cutting system 102 it may take a period of time to change cutting system 102 from one cutting pattern to a cutting pattern that is appropriate for cutting the set of images 200, 202, 204, 206 and 208 organized as shown in FIG. 5. The time required to change cutting system 102 so that cutting system 102 can cut a print 70 with images organized according to the arrangement shown in FIG. 5 can be longer than the overall time required to print the set of images 200, 202, 204, 206, and 208 using the print organization of FIG. 4 where cutting system 102 is already configured to cut prints organized using the print organization. Accordingly, in such a case, controller 82 can elect the organization FIG. 4. Similarly, where the configuration of finishing system 100 is such that printing using either of the organization of FIG. 4 or the organization of FIG. 5 an amount of time required to change from an existing configuration of finishing system 100 to a configuration that is appropriate for finishing prints having the set of images printed under both of the organizations can be added to a printing time for each organization of images to determine which organization of the set of images will result in more rapid rate of production.

It will be understood that the use of the embodiments shown in FIGS. 4 and 5 reduce the amount of any post finishing production labor involved in producing prints from images 200, 202, 204, 206, and 208 by orienting all of the prints in the same orientation thus increasing the rate at which the prints based upon images 200, 202, 204, 206, and 208 can be delivered.

It will further be understood the use of the organizations shown in FIGS. 4 and 5 leave meaningful portions of a printable area of receiver 26 within receiver width 212 of receiver 26 and first length 214 (FIG. 4), and second length 216 (FIG. 5) unused which results in waste and that a different organization of images 200, 202, 204, 206, and 208 may be possible that eliminates such waste.

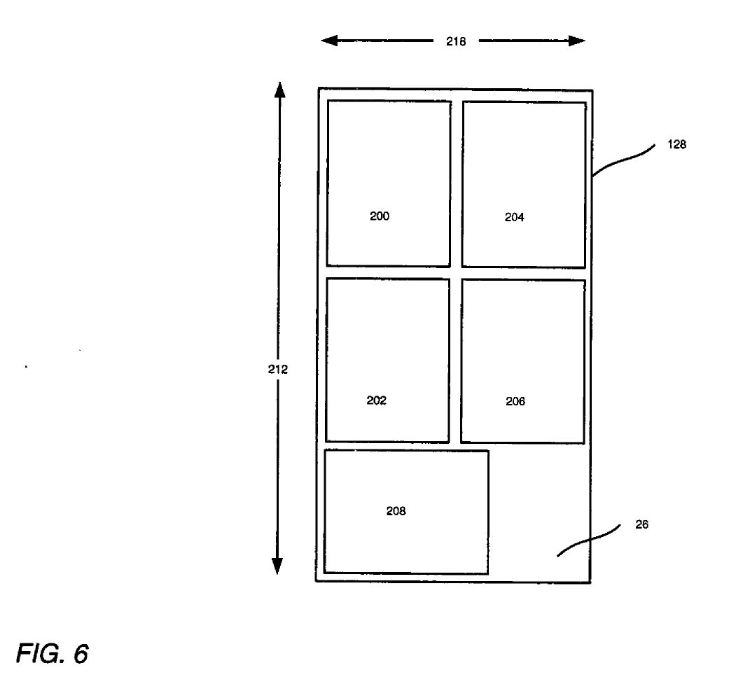

Such issues can be addressed by controller 82 when an efficiency priority setting is determined. As is shown in FIG. 6, when an efficiency priority setting is determined, an organization of the set of images 200, 202, 204, 206 and 208 is made that achieves more efficient use of receiver 26. Here too, this printing organization may require that a configuration of finishing system 100 be changed, adding production time. Further, it will be clear that the prints produced with images 200, 202, 204, 206, and 208 printed using the arrangement of FIG. 6 will have different orientations as they leave printer 20 which in certain instances will increase the time required to deliver prints made from images 200, 202, 204, 206 and 208. However, the organization of FIG. 6 arrangement can result in reduced expense through more efficient use of receiver 26 and through reduced wear and tear on printer 20 and reduced energy used through reduced printing time required to print.

Accordingly, once that a priority determination is made, controller 82 can automatically select from among the available organizational choices in a manner that is guided by the priority setting to make a variety of decisions automatically that are currently left to an operator's discretion.

Once that a determination is made as to the organization of the images, controller 82 and supply controller 150 can be used to identify a receiver length to allow the set of images 200, 202, 204, 206 and 208 to be printed according to the determined organization and to cause a sheet 128 of receiver 26 to be provided for printing having the identified length (step 178). It will be appreciated that, at a minimum, the length of a sheet 128 of receiver 26 that is used will be a function at least of the organization of the prints as the organization dictates the minimum necessary length of a sheet 128 of receiver 26. In this regard, it will be observed that using the different print organizations show in FIGS. 4, 5 and 6, the length of receiver 26 required for printing the set of images 200, 202, 204, 206 and 208 is different and depends on the organization of the set of images 200, 202, 204, 206 and 208. As is shown in FIG. 4, a first length 214 is required that is longer than second length 216 required in the organization shown in FIG. 5 which is longer still than the third length 218 shown in the organization shown in FIG. 6.

In the printer 20 of FIG. 2, the length of a sheet 128 of receiver 26 to be used in printing a set of images is determined by controller 82 based at least in part upon the minimum length required to record the images on receiver 26 as organized.

In certain embodiments, the length of a sheet 128 of receiver 26 that is provided can extend beyond such a minimum length. The extent to which the length of a sheet 128 of receiver 26 has additional length that extends beyond the minimum length can be determined based upon the determined priority. For example, it may be more efficient to provide additional length of a sheet 128 of receiver 26 to enable faster handling of a print 70 made using sheet 128 or to otherwise facilitate finishing of print 70 or any post finishing processing of a print 70. The extent to which the length of sheet 128 extends beyond such a minimum can additionally be determined based upon the processing data or upon requirements of the process used to print the images, the finishing system or any post-finishing activities.

The determination of the length can be fully variable or the determination can be made such as between one of set of predetermined receiver lengths.

Once that the length is determined, controller 82 can provide appropriate signals that cause supply controller 150 to provide a sheet 128 of receiver 26 having the determined length.

The set of images 200, 202, 204, 206, and 208 is then printed on the supplied sheet 128 of receiver 26 at in accordance with the determined organization (step 180) and a print 70 having the set of images 200, 202, 204, 206, and 208 is subject to a finishing operation to provide prints having the defined size and shape (step 182). These steps are generally performed in any manner known in the printing and finishing arts.

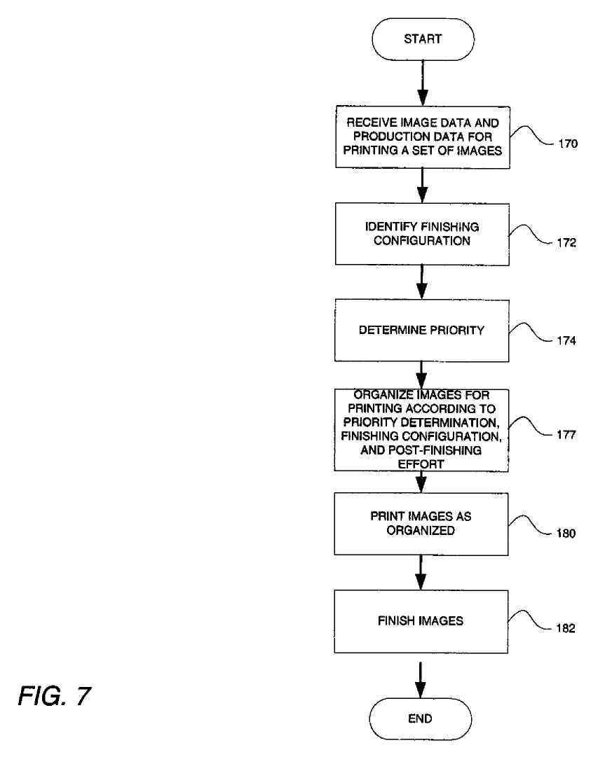

It will be appreciated that as noted above, additional post finishing processing steps may be required depending on the way in which the set of images 200, 202, 204, 206 and 208 are printed and finished. Accordingly in the embodiment of FIG. 7, a step of organizing the images for printing (step 177) comprises organizing the images for printing according to the priority setting, the finishing configuration and post-finishing processing.

In this regard, controller 82 can identify when a particular organization of the set of images or the use of a particular finishing configuration will require post-finishing effort to complete the job of producing prints from the images. The extent of such post finishing processing effort can be factored by controller 82 into the process of determining which organization to use for example in making a set of prints based upon images 200, 202, 204, 206 and 208. For example, where an output rate priority is selected, controller 82 will consider the overall amount of time required to deliver the finished prints from images 200, 202, 204, 206 and 208 including an estimated amount of time required to perform any post finishing steps such as sorting or collating that are required by a combination of the organization of the images during printing and finishing configurations. Information regarding such additional post finishing steps can be programmed into printer 20 and for example stored in memory 88 or made available to printer 20 by way of communication system 90 from a remote database.

Similarly, where additional post finishing efforts are associated with additional costs, such costs are factored by controller 82 into determining an organization for a set of images when an efficiency priority setting is in effect. Here too, information regarding the costs of such additional post finishing steps can be programmed into printer 20 and for example stored in memory 88 or made available to printer 20 by way of communication system 90 from a remote database and such information can include costs data associated with such post finishing operations.

It will be understood that the embodiment of receiver supply 32 that is described herein for supplying receiver 26 for printing is exemplary only and that other forms of receiver supply 32 known in the art as being capable of providing variable lengths of cut sheets of a receiver 26 from a web 124 of such a receiver 26 in response to electronic signals can be used. Similarly, it will be appreciated that the methods that are described herein are equally applicable to determining which of a supply of different lengths of cut sheet receiver are to be used and that in this regard, the methods described herein can be used to select from among different sizes of cut sheets from a conventional receiver supply 32 that is capable of delivering such different sizes of cut sheet receivers to a receiver transport system.

It will be appreciated that there are circumstances where all of the images in a set of images cannot be printed using a single sheet 128 of receiver 26. This can occur, for example, where such images cannot be printed within a printable length of the receiver or printable area on a receiver.

Accordingly, in some embodiments, organizing steps such as steps 176 or 177 can include determining that the set of images cannot be organized for printing on a sheet 128 of receiver 28. In response to such a determination, the steps of organizing the images in a set of images for printing in the defined size and shapes will include organizing the images for printing in the defined sizes and shapes using a length of a sheet of receiver and using a length of at least one additional receiver. Such organizing will be performed based upon the determined priority setting and the finishing configuration and, optionally, any post-processing effort required to produce prints for each of the images in a set using the receiver and the at least one additional receiver as generally described above.

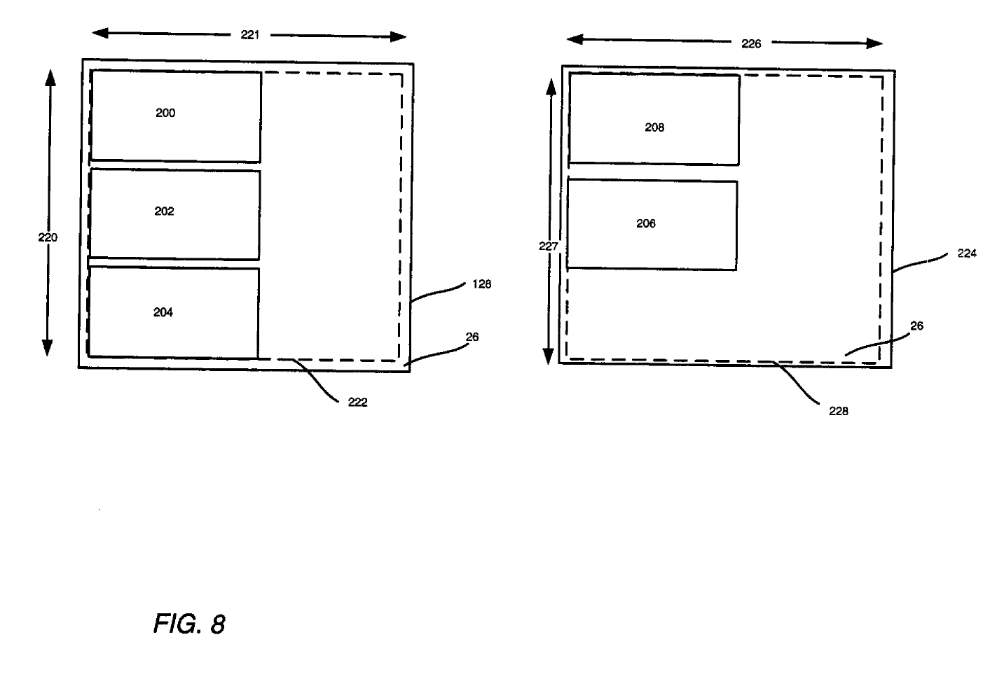

As shown in FIG. 8, in one example, a sheet of receiver 128 can have a print width 220 and a printable length 221 that define a printable area 222 within which the set of images 200, 202, and 204, can be organized for printing. However, printable area 222 does not provide sufficient area for both images 206 and 208 to be organized for printing on sheet 128 of receive 26. Accordingly, an additional sheet 224 is provided that provides an additional printable length 226 along a print width 227 to create additional printable area 228 within which images 206 and 208 can be printed. As is noted above, the organization of images 200, 202, 204, 206 and 208 within printable area 222 and additional printable area 228 will be determined based upon the determined priority and the finishing configuration and, optionally, any post-processing effort required to produce prints for each of the set of images using the receiver and at least one additional receiver.

For example, as shown in FIG. 8, where an output rate priority is selected and where a determined finishing configuration indicates that a finishing system is configured to cut sheets 128 and 224 along a length, the output rate priority setting may suggest the organization shown in FIG. 8.

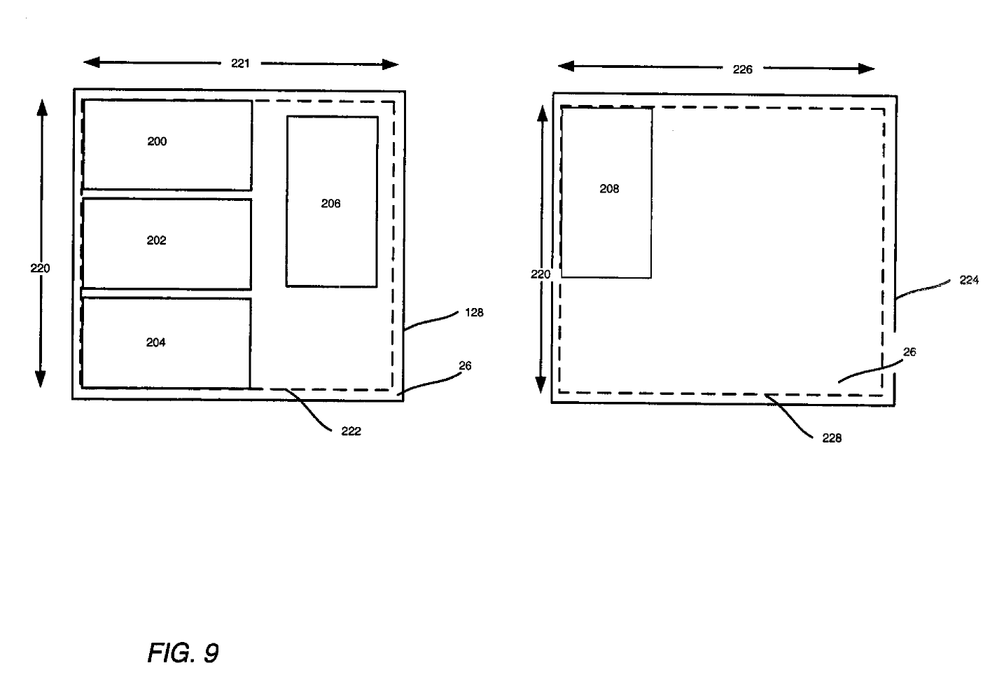

However, as is shown in FIG. 9 where an efficiency priority setting is determined, the set of images 200, 202, 204, 206 and 208 can be organized for printing within printable area 222 and additional printable area 228 with an organization that concentrates images 200, 202, 204, and 206 on sheet 128. This allows image 208 to be formed on additional sheet 224 in a manner that requires the shortest possible amount of printing time for additional sheet 224 or the smallest amount of use of additional sheet 224. Here, the additional printable length 226 of additional sheet 224 is shown as being the same as printable length 221 of sheet 128.

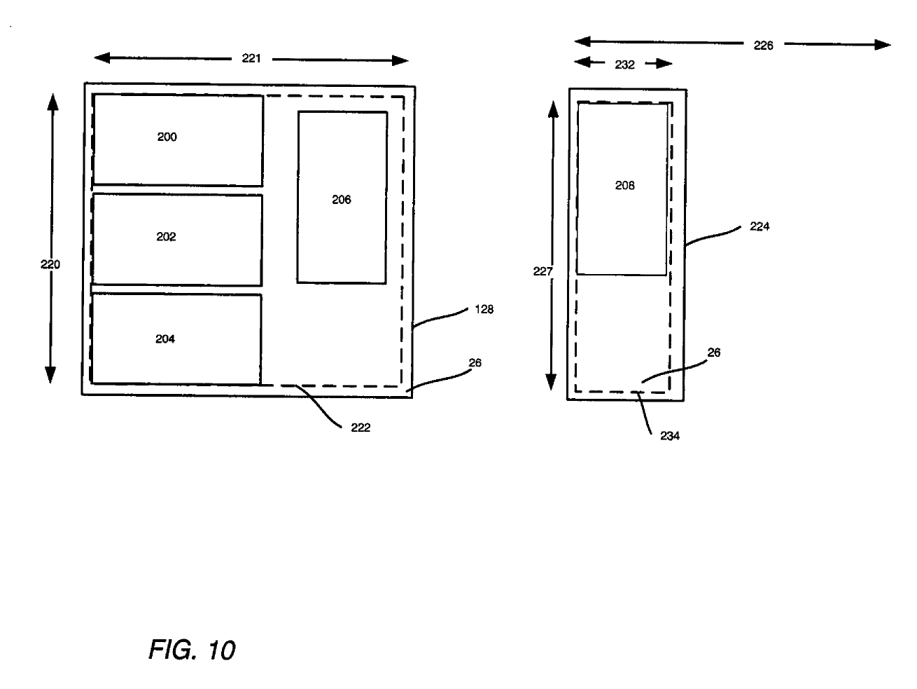

FIG. 10 shows an example of an organization of the set of images 200, 202, 204, 206 and 208 that can be used, for example, when an efficiency priority setting is determined. Here, an additional sheet 224 is used that provides a printable length 232 on additional sheet 224 that is shorter than additional printable length 226 to provide a printable area 234 in which image 208 can be organized so that printable area 234 can be made smaller than additional printable area 228. This makes more efficient use of receiver 26. Optionally, an additional sheet 224 can have a different print width 227. Accordingly, in this example, a step of determining a length of a receiver (step 178) comprises determining a length for sheet 128 and a length for additional sheet 224 that are based upon the printable lengths 221 and 232 required to record images 200, 202, 204, 206 and 208 as organized for printing on receiver 128 and on additional receiver sheet 224.

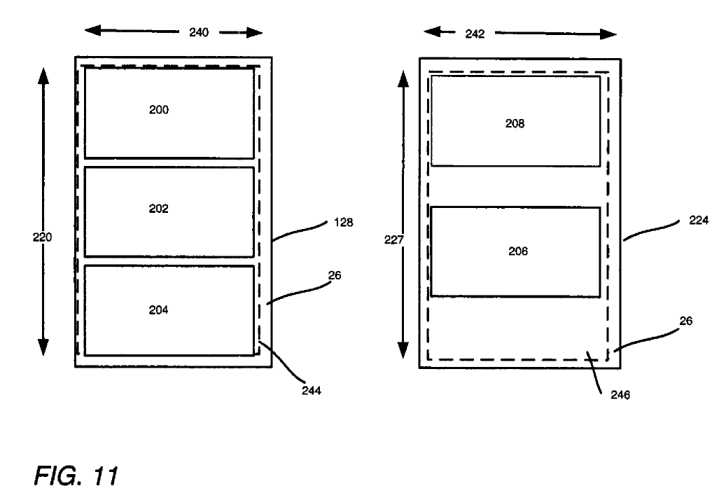

FIG. 11 shows still another example of an organization of images 200, 202, 204, 206 and 208 that can be used for example, when an efficiency priority setting is determined. As shown here, a step of determining a length of a receiver 26 further comprises determining a printable length 240 for sheet 128 of receiver 26 and an additional printable length 242 for the additional sheet 224 of receiver 26 that are sized to provide a printable area 244 and an additional printable area 246 required to record images 200, 202, 204, 206 and 208 on sheet 128 and an additional sheet 224.

It will be appreciated that for print engines 22 that are capable of printing from one edge of a sheet to the other, the printable length and the length of the sheet can be the same. However as is noted elsewhere above, the length of receiver 26 in a sheet 128 can be determined based on other factors that may cause a length of a sheet of receiver 26 to be larger than a printable length.

It will be understood that in the methods described herein are not limited to use with electrophotographic printers, such as the electrophotographic printer 20 described herein, and that any form of printing technology can be used. Examples of such other forms of printing technology include ink jet printing technology, thermal printing technology, laser printing technology and metal or other etching printing technology.

The invention has been described in detail with particular reference to certain preferred embodiments thereof, but it will be understood that variations and modifications can be effected within the spirit and scope of the invention.

### PARTS LIST

20 printer
22 print engine
24 toner
25 toner image
26 receiver
28 receiver transport system
30 surface
32 receiver supply
36 motor
38 rollers
40 printing module
42 printing module
44 printing module
46 printing module
48 printing module
50 transfer subsystem
52 cleaning mechanism
60 fuser
70 print
82 controller
84 user input system
86 sensors
88 memory
90 communication system
92 external device(s)
94 output system
100 finishing system
102 cutting system
104 automatic folding system
120 frame
122 support structure
124 web of receiver
126 roll of receiver
128 sheet
130 lead pinch roller
132 lead pinch roller
134 trailing pinch roller
136 trailing pinch roller
138 receiver supply transport path
140 biasing member
142 biasing member
144 first pinch roller motor
146 second pinch roller motor
150 supply controller
152 leading edge of sheet
154 cutter
156 trailing edge of sheet
158 cut line
160 leading edge of web
162 surface
170 receiver image and production data step
172 identify finishing configuration step
174 determine priority step
176 organize images for printing step
177 organize images for printing step
178 determine receiver length and provide receiver of determined length step
180 print images as organized step
182 finish images step
200 image
202 image
204 image
206 image
208 image
212 width of receiver
214 first length of receiver
216 second length of receiver
218 third length of receiver
220 print width
221 printable length of receiver sheet
222 printable area of receiver sheet
224 additional receiver sheet
226 additional printable length of
228 additional printable area
232 printable length
240 printable length of receiver
242 additional printable length
244 printable area
246 additional printable area

What is claimed is:

1. A printer comprising:
a source of image data and production data for use in printing a set of images, with each image having a defined size and shape;
a receiver supply having a web of receiver and a cutter adapted to cut the web of receiver to a determined length;
a print engine to print the images on the receiver;
a finishing system that is configurable between at least two configurations;
a user input system that receives user input from which a priority setting can be determined between an output rate priority and an efficiency priority; and
a controller that determines the configuration of the finishing system, receives the image data and production data and that determines a priority setting;
wherein the controller determines an organization of the images for printing the images on the receiver in the defined sizes and shapes based upon the determined priority setting and the determined configuration of the finishing system, and
wherein the controller determines a length of the receiver based on the organization of the images and causes the cutter to cut the web of receiver to supply the determined length of the receiver.

2. The printer of claim 1, wherein the controller determines a output rate priority and in response to such determining the controller determines an organization for the images for printing on the receiver in a manner that reduces an amount of time required to render the prints and to finish the prints so that the finished prints can be produced in accordance with the production data using the determined finishing configuration.

3. The printer of claim 1, wherein the controller determines an efficiency priority setting and the controller determines an organization for the images for printing in a manner that reduces the length of receiver required to print the images as organized.

4. The printer of claim 1, wherein the set of images is organized in a manner that is based at least in part upon a time to complete any post-finishing effort required to provide prints from the set of images as organized.

5. The printer of claim 1, wherein the set of images is organized to provide prints in a manner is at least based upon a cost of the post-finishing effort required to provide prints from the set of images as organized.

6. The printer of claim 1, wherein the images are further organized based upon the post-finishing effort required to provide prints having the defined size and shape as organized.

7. The printer of claim 1, wherein the controller further causes the print engine to form the images on the receiver and the finishing system to finish the receiver.

8. The printer of claim 1, wherein the finishing comprises cutting the receiver to provide images having the defined size and shape.

9. The printer of claim 1, wherein the finishing comprises folding the receiver to provide images having the defined size and shape.

10. The printer of claim 1, wherein the source of image data and production data comprises a communication system.

11. The printer of claim 1, further comprising a communication system that can detect a signal from which the controller can determine the priority setting.

12. The printer of claim 1, wherein the step of determining a length is made within a set of predetermined lengths.

13. The printer of claim 1, wherein the length is further determined based on production data.

14. The printer of claim 1, wherein the length is further determined to provide additional length to facilitate finishing.

15. The printer of claim 1, wherein the length is further determined to provide additional length to facilitate post-finishing processing.

16. The printer of claim 1, wherein the controller organizes the images by first determining that the images cannot be organized for printing on the receiver at the shapes and sizes defined for each of the images and, in response, organizes the images for printing on the receiver and at least one additional receiver.

17. The printer of claim 1, wherein the controller organizes the images by first determining that the images cannot be organized for printing within a printable length of the receiver and, in response, organizes the images for printing on a printable length of the receiver and on an additional printable length of at least one additional receiver and wherein the controller causes the receiver supply to supply the receiver having a length that is based upon the printable length of the receiver and the additional receiver having a length that is based upon the additional printable length.

18. The printer of claim 17, wherein the printable length and the additional printable length are different.

19. A printer comprising:
a means for receiving image data and production data for printing a set of images with each image having a defined size and shape;
a means for determining a finishing configuration of a finishing system;
a means for determining a priority setting between an output rate priority and an efficiency priority;
a means for organizing the images for printing on the receiver in the defined size and shapes, based upon the determined priority and the finishing configuration; and;
a means for determining a receiver length that is based on the organization of the images;
a means for providing a receiver of the determined length for printing;
a means for printing the set of images on the provided receiver at the defined size and shape as organized; and
a means for finishing the receiver to provide prints of each of the images with each print having the defined size and shape for the image.
